(19) United States
(12) Patent Application Publication
(10) Pub. No.: US 2014/0277765 A1
(43) Pub. Date: Sep. 18, 2014

(54) HUMAN-BUILDING INTERACTION FRAMEWORK FOR PERSONALIZED COMFORT DRIVEN SYSTEM OPERATIONS IN BUILDINGS

(71) Applicants: Farrokh Jazizadeh Karimi, Los Angeles, CA (US); Burcin Becerik-Gerber, Los angeles, CA (US); Michael D. Orosz, Los Angeles, CA (US); Tatiana Kichkaylo, Mountain View, CA (US); Ali Ghahramani, Los Angeles, CA (US)

(72) Inventors: Farrokh Jazizadeh Karimi, Los Angeles, CA (US); Burcin Becerik-Gerber, Los angeles, CA (US); Michael D. Orosz, Los Angeles, CA (US); Tatiana Kichkaylo, Mountain View, CA (US); Ali Ghahramani, Los Angeles, CA (US)

(73) Assignee: UNIVERSITY OF SOUTHERN CALIFORNIA, Los Angeles, CA (US)

(21) Appl. No.: 14/213,475

(22) Filed: Mar. 14, 2014

Related U.S. Application Data
(60) Provisional application No. 61/789,810, filed on Mar. 15, 2013.

(51) Int. Cl. G05D 23/19

(52) U.S. Cl. CPC G05D 23/1932
USPC 700/276

(57) ABSTRACT

A computer data processing system may provide control information for controlling how an environmental control system controls an environment within a building. The computer data processing system may receive and store reports from multiple users and/or may receive and store reports at different times from a user. Each report may provide information concerning how the user perceives the comfort level of the user's environment at the time the user supplies the information. The computer data processing system may determine and generate the control information for controlling how the environmental control system controls the environment based on the information concerning how each user perceives the comfort level of the user's environment at the time each user provides the information. In addition or instead, the computer data processing system may determine and generate such control information based on the information concerning how a user perceives the comfort level of the user's environment at the different times the user supplies the information.

### CROSS-REFERENCE TO RELATED APPLICATION

This application is based upon and claims priority to U.S. provisional patent application 61/789,810, entitled “Human-Building Interaction (HBI) Framework For Personalized Comfort Driven System Operations In Office Buildings,” filed Mar. 15, 2013, attorney docket number 028080-0859. The entire content of this application is incorporated herein by reference.

### STATEMENT REGARDING FEDERALLY SPONSORED RESEARCH

This invention was made with government support under Grant No. DE-EE0004019, awarded by the Department of Energy (DOE), and Grant No. 1201198, awarded by the National Science Foundation (NSF). The government has certain rights in the invention.

### BACKGROUND

1. Technical Field

This disclosure relates to efficient and effective control of personalized comfort-driven system operations in buildings, such as HVAC systems.

2. Description of Related Art

Thermal comfort can be a main driving factor in defining operational settings of HVAC systems, and it can greatly impact energy efficiency in buildings. Lack of information about human related variables can result in using unrepresentative operational settings which, in turn, could bring about low efficiency in HVAC operations.

Buildings can be major consumers of energy in the U.S. (about 42% of total annual energy consumption, see BED-Book, Building Energy Data Book (2011)) and around the world (i.e., 20% to 40% of annual energy consumption, see L. Perez-Lombard, J. Ortiz, C. Pout, “A review on buildings energy consumption information”, Energy Build, 40 (2008) 394-398).

Heating, ventilation, and air conditioning (HVAC) systems can be the largest contributors to the energy consumption in buildings. In the U.S., these systems can account for almost 43% of energy consumption, see BED-Book, Building Energy Data Book (2011). Thermal comfort can be one of the driving factors in the design and operation of HVAC systems and therefore, one of the key factors in determining the energy demand of these systems.

Determination of the operational settings of HVAC systems can play an important role in efficiency. Efficiency, in this context, can be described as the performance of an HVAC system in providing and maintaining satisfactory indoor thermal conditions, while reducing energy expenditures related to system operations.

In order to provide satisfactory indoor thermal conditions, HVAC operational settings are often determined based on recommendations of industry standards. These standards, in the simplest form, recommend satisfactory temperature ranges for different seasons. For example, ISO EN 7730, 2005 recommends an indoor environment with the temperature range of 23.5° C. to 25.5° C. in order to have 94% of building occupants comfortable in the summer, while the recommended range for indoor environment temperature is 21.0° C. to 23.0° C. to have 94% of the occupants comfortable in the winter, see ISO EN 7730, “Moderate thermal environments—Determination of the PMV and PPD indices and specification of the conditions for thermal comfort”, International Standards Organization, Geneva (2005).

More advanced thermal comfort models in standards can be based on heat budget models. The PMV-PPD (Predicted Mean Vote-Predicted Percentage of Dissatisfied) is a prevalent thermal comfort model that has been used by the standards since its introduction by Fanger, see P. O. Fanger (Ed.), “Thermal comfort: analysis and applications in environmental engineering”, Robert E. Kriger Publishing Co, 1970, in the 1970s. Thermal comfort is sometimes defined as the “condition of mind, which expresses satisfaction with the thermal environment,” see, ASHRAE, Thermal Environmental Conditions for Human Occupancy, 55-2004 (2004), and can be affected by different indoor environmental and human related variables, which can make it a complex variable to be quantified for individual users.

Although heat budget models account for some of the human related factors, such as clothing values and metabolic rates, determination of user related factors can be a challenging task. Thus, these factors are sometimes estimated as constant values based on standards' recommendations. Accordingly, the application of the standard recommended settings, in the absence of contextual user information, could potentially result in dissatisfactory experiences.

Several research studies have pointed to occupant dissatisfaction with thermal indoor conditions, see W. Guo, M. Zhou, “Technologies toward thermal comfort-based and energy-efficient HVAC systems: A review” (2009) 3883-3888; S. Karjalainen, O. Koistinen, “User problems with individual temperature control in offices”, Build. Environ. 42 (2007) 2880-2887. Preliminary studies of three HVAC operated buildings in Southern California, where HVAC systems usually operate in cooling mode, also showed that a large percentage of occupants perceive the indoor environment as cool to cold. Out of 294 votes in two of the buildings in fall and summer seasons, about 60% of the votes perceived the indoor environment as cool to cold. In the third building, 34% of the occupants reported dissatisfaction and, in 49% of the cases, occupants perceived their environment somewhat cool to cold.

Dissatisfaction with the indoor environment can bring about low efficiency in HVAC system operations. Moreover, mitigating solutions that some occupants might use to compensate for the discomfort, such as using portable space heaters in buildings, where the indoor environment is cooler than the desired, could cause excessive operations of HVAC systems, aggravating the discomfort problem and consuming more energy, and therefore leading to lower efficiencies. The temperature in the room, where the portable space heater is used, rises which, in return, increases the temperature in the thermal zone. This issue can result in the HVAC system compensating for the excessive heat load. As a result, the temperature in all of the rooms in the thermal zone may drop, affecting all of the occupants in that zone.

Moreover, thermal comfort can also be a complex context dependent quantity. Occupants' thermal comfort zone has been shown to vary with seasonal variations, regional and cultural contexts, implying that thermal comfort is time, location, and context dependent, see J. Van Hoof, “Forty years of Fanger's model of thermal comfort: comfort for all?, Indoor Air, 18 (2008) 182-201; M. A. Humphreys, M. Hancock, “Do people like to feel ‘neutral’?: Exploring the variation of the desired thermal sensation on the ASHRAE scale”, Energy Build. 39 (2007) 867-874; D. A. McIntyre, “CHAMBER STUDIES—REDUCTION AD ABSURDUM?, Energy Build, 5 (1981) 89-96.

Advanced HVAC control algorithms with comfort and energy multivariable objective functions have been extensively studied. Quantification of comfort ranges can be a critical component of a control loop in operating HVAC systems. The PMV index has been used in several studies as the metric for user comfort integration, see D. Kolokotsa, G. Saridakis, A. Pouliezos, G. S. Stavrakakis, “Design and installation of an advanced EIB fuzzy indoor comfort controller using Matlab”, Energy Build. 38 (2006) 1084-92; A. I. Dounis, D. E. Manolakis, A. Argriou, “A fuzzy rule-based approach to achieve visual comfort conditions”, In J. Syst. Sci. 26 (1995) 1349-61; A. Guillemin, N. Morel, “Experimental results of a self-adaptive integrated control system in buildings: a pilot study”, Solar Energy. 72 (2002) 397-403; D. Kolokotsa, K. Niachou, V. Geros, K. Kalaitzakis, G. S. Stavrakakis, M. Santamouris, “Implementation of an integrated indoor environment and energy management system”, Energy Build. 37 (2005) 93-99; K. Dalamagkidis, D. Kolokotsa, K. Kalaitzakis, G. S. Stavrakakis, “Reinforcement learning for energy conservation and comfort in buildings”, Build. Environ. 42 (2007) 2686-2698; F. Calvino, M. La Gennusa, G. Rizzo, G. Scaccianoce, “The control of indoor thermal comfort conditions: introducing a fuzzy adaptive controller”, Energy Build. 36 (2004) 97-102, P. Bermejo, L. Redondo, D. L. Ossa, D. Rodriguez, J. Flores, C. Urea, J. A. Gamez, J. M. Puerta, “Design and simulation of a thermal comfort adaptive system based on fuzzy logic and on-line learning”, Energy Build. 49 (2012) 367-379. As noted in the literature, the PMV index can depend on a number of parameters, including environmental and human related variables. Assumptions for human related variables have been used in the absence of information about building occupants, see K. Dalamagkidis, D. Kolokotsa, K. Kalaitzakis, G. S. Stavrakakis, “Reinforcement learning for energy conservation and comfort in buildings”, Build. Environ. 42 (2007) 2686-2698; F. Calvino, M. La Gennusa, G. Rizzo, G. Scaccianoce, “The control of indoor thermal comfort conditions: introducing a fuzzy adaptive controller”, Energy Build. 36 (2004) 97-102. Incorporation of these assumptions can cause the index to be less representative of the dynamic occupancy characteristics in buildings. Furthermore, the calculation of the PMV may require a number of indoor environmental variables. These variables include temperature, humidity, air velocity, and radiant temperature. Measurement of these variables can require a customized sensing system, which can compound the calculation of this index. A number of studies proposed sensor network solutions for increasing the accuracy of the PMV calculation, see W. L. Tse, W. L. Chan, “A distributed sensor network for measurement of human thermal comfort feelings”, Sens Actuators A Phys. 144 (2008) 394-402; J. Kang, Y. Kim, H. Kim, J. Jeong, S. Park, “Comfort sensing system for indoor environment”, 1 (1997) 311-314. However, due to the complexity of sensor networks, practical applications of these sensor systems for building control can be limited, see D. Daum, F. Haldi, N. Morel, “A personalized measure of thermal comfort for building controls”, Build. Environ. 46 (2011) 3-11. Therefore, a number of studies proposed that user provided information be used for obtaining the metric for thermal comfort perceptions in the control logic of building systems. Guillemin and Morel used occupants' preferences in the form of temperature set points through keyboards in each room, see A. Guillemin, N. Morel, “Experimental results of a self-adaptive integrated control system in buildings: a pilot study”, Solar Energy. 72 (2002) 397-403. Murakami et al. used user input for combination of binary preferences of warmer and cooler along with ASHRAE thermal sensation scale through a user interface, see Y. Murakami, M. Terano, F. Obayashi, M. Honma, “Development of cooperative building controller for energy saving and comfortable environment”, pt.2 (2007) 1078-87. Daum et al. used user input in the form of too hot/too cold complaints along with a probabilistic approach for determination of user comfort profiles, see D. Daum, F. Haldi, N. Morel, “A personalized measure of thermal comfort for building controls”, Build. Environ. 46 (2011) 3-11. Controlling building systems through user provided set points has the drawback that set points in buildings are not necessarily equal to perceived room temperatures. Moreover, user defined set points might not always lead to user comfort. Accordingly, a number of studies proposed mechanisms for learning users' comfort ranges. Based on their observation, Guillemin et al. (A. Guillemin, N. Morel, “Experimental results of a self-adaptive integrated control system in buildings: a pilot study”, Solar Energy. 72 (2002) 397-403) proposed that an alternative algorithm is needed as occupants were not able to propose set points that bring about their comfortable conditions. Daum et al. (see, D. Daum, F. Haldi, N. Morel, “A personalized measure of thermal comfort for building controls”, Build. Environ. 46 (2011) 3-11) proposed an approach to update a default probabilistic representation of user comfort profiles using user-provided information obtained through the above-mentioned binary buttons. In another approach, Bermejo et al. (see, P. Bermejo, L. Redondo, D. L. Ossa, D. Rodriguez, J. Flores, C. Urea, J. A. Gamez, J. M. Puerta, “Design and simulation of a thermal comfort adaptive system based on fuzzy logic and on-line learning”, Energy Build. 49 (2012) 367-379) proposed to use static fuzzy rules for the PMV and update the thermal comfort index as occupants interacted with the thermostats in their rooms.

The application of thermal comfort metrics may be coupled with control mechanisms in order to enable conditioning of indoor environments. Due to the fuzzy nature of thermal comfort, several studies proposed fuzzy logic controllers to enable the provision of thermal comfort in buildings, see D. Kolokotsa, G. Saridakis, A. Pouliezos, G. S. Stavrakakis, “Design and installation of an advanced EIB fuzzy indoor comfort controller using Matlab”, Energy Build. 38 (2006) 1084-92; F. Calvino, M. La Gennusa, G. Rizzo, G. Scaccianoce, “The control of indoor thermal comfort conditions: introducing a fuzzy adaptive controller”, Energy Build. 36 (2004) 97-102; Duan Pei-yong, L. Hui, “A novel data-based control strategy of dynamic thermal comfort for inhabited environment” (2010) 4865-9; M. M. Gouda, “Fuzzy ventilation control for zone temperature and relative humidity”, 1 (2005) 507-12; M. Hamdi, G. Lachiver, “A fuzzy control system based on the human sensation of thermal comfort”, 1 (1998) 487-92; Ma Hong-Li, Zhu Bang-Tai,” Application of self-adaptive fuzzy logic controller in building automation system”, J. Hebei Univ. Sci. Technol. 26 (2005) 68-71; M. Nowak, A. Urbaniak, “Utilization of intelligent control algorithms for thermal comfort optimization and energy saving” (2011) 270-274. Additionally, multi-agent simulations, see A. I. Dounis, C. Caraiscos, “Advanced control systems engineering for energy and comfort management in a building environment—A review”, Renewable and Sustainable Energy Reviews. 13 (2009) 1246-1261, and neural network based computing methods, see A. Ben-Nakhi, M. A. Mahmoud, “Cooling load prediction for buildings using general regression neural networks”, Energy Conversion and Management. 45 (2004) 2127-41; S. Atthajariyakul, T. Leephakpreeda, “Neural computing thermal comfort index for HVAC systems”, Energy Conversion and Management. 46 (2005) 2553-65, have been investigated for advanced building controls. Adaptive fuzzy controllers, as well as, genetic and gradient-based algorithms have been used for multi-objective optimization of occupant comfort and building energy consumption, see M. Bruant, G. Guarracino, P. Michel, “Design and tuning of a fuzzy controller for indoor air quality and thermal comfort management”, Int J Sol Energy. 21 (2001) 81-109; D. Kolokotsa, D. Tsiavos, G. S. Stavrakakis, K. Kalaitzakis, E. Antonidakis, “Advanced fuzzy logic controllers design and evaluation for buildings' occupants thermal-visual comfort and indoor air quality satisfaction”, Energy Build. 33 (2001) 531-43; S. Atthajariyakul, T. Leephakpreeda, “Real-time determination of optimal indoor-air condition for thermal comfort, air quality and efficient energy usage”, 36 (2004) 720-733; J. Wen, T. F. Smith, “Development and validation of adaptive optimal operation methodology for building HVAC systems”, Proceedings of the SPIE—The International Society for Optical Engineering. 5605 (2004) 000005-16.

As noted above, the majority of these advanced control mechanisms focused on standard thermal comfort index, namely the PMV or other indoor quality indices, as control variables. However, the integration of human related variables still remains a challenging problem, for which constant assumptions are used in majority of the cases. In many of the cases, the proposed advanced control algorithms require retrofits to the HVAC system components, making it difficult to implement in practice. Despite these difficulties, the application of advanced algorithms has shown improvements in HVAC system operations. However, they are better suited for new buildings, where customization of HVAC components may be more feasible.

Evaluation of the proposed strategies for improving thermal comfort in buildings is another important aspect to consider. As noted above, many of the proposed approaches require modifications to the building system components, which introduce a challenge for evaluations in real building settings. Accordingly, simulations, see A. I. Dounis, D. E. Manolakis, A. Argriou, A fuzzy rule-based approach to achieve visual comfort conditions, Int. J. Syst. Sci. 26 (1995) 1349-61; K. Dalamagkidis, D. Kolokotsa, K. Kalaitzakis, G. S. Stavrakakis, “Reinforcement learning for energy conservation and comfort in buildings”, Build. Environ. 42 (2007) 2686-2698; F. Calvino, M. La Gennusa, G. Rizzo, G. Scaccianoce, “The control of indoor thermal comfort conditions: introducing a fuzzy adaptive controller”, Energy Build. 36 (2004) 97-102; P. Bermejo, L. Redondo, D. L. Ossa, D. Rodriguez, J. Flores, C. Urea, J. A. Gamez, J. M. Puerta, “Design and simulation of a thermal comfort adaptive system based on fuzzy logic and on-line learning”, Energy Build. 49 (2012) 367-379; J. J. Saade, A. H. Ramadan, “Control of thermal-visual comfort and air quality in indoor environments through a fuzzy inference-based approach”, International Journal of Mathematical Models and Methods in Applied Sciences. 2 (2008) 213-221; L. Klein, J. Kwak, G. Kavulya, F. Jazizadeh, B. Becerik-Gerber, P. Varakantham, M. Tambe, “Coordinating occupant behavior for building energy and comfort management using multi-agent systems” (2012), experimental chamber studies, see D. Kolokotsa, G. Saridakis, A. Pouliezos, G. S. Stavrakakis, “Design and installation of an advanced EIB fuzzy indoor comfort controller using Matlab”, Energy Build. 38 (2006) 1084-92, and studies in limited areas such as one or two rooms, see A. Guillemin, N. Morel, Experimental results of a self-adaptive integrated control system in buildings: a pilot study, Solar Energy. 72 (2002) 397-403; F. Calvino, M. La Gennusa, G. Rizzo, G. Scaccianoce, “The control of indoor thermal comfort conditions: introducing a fuzzy adaptive controller”, Energy Build. 36 (2004) 97-102, are commonly used for validation of the algorithms. Although simulation is a well-established approach, and is extensively used in studies, many challenging aspects of the control strategies might not be observed in simulations. Moreover, building component characteristics, occupant characteristics as well as various unpredicted conditions in buildings could affect indoor environments, and they are usually difficult to be modeled accurately in simulation.

A number of studies evaluated their proposed control algorithms in larger scales. Kolokotsa et al. (see, D. Kolokotsa, K. Niachou, V. Geros, K. Kalaitzakis, G. S. Stavrakakis, M. Santamouris, “Implementation of an integrated indoor environment and energy management system”, Energy Build. 37 (2005) 93-99, implemented a fuzzy controller in two buildings in different seasons of the year for different comfort indices, including thermal, visual, and air quality related comfort and showed more than 30% of reduction in energy consumption. Murakami et al. (see, Y. Murakami, M. Terano, F. Obayashi, M. Honma, “Development of cooperative building controller for energy saving and comfortable environment”, pt.2 (2007) 1078-87) evaluated their proposed algorithm for improving user comfort in an open plan office setting. Their proposed approach, which set daily set points, was evaluated through a collective voting by a group of 50 occupants and showed that the energy consumption was almost the same before and after the implementation.

### SUMMARY

A computer data processing system may provide control information for controlling how an environmental control system controls an environment within a building. The computer data processing system may receive and store reports from multiple users and/or may receive and store reports at different times from a user. Each report may provide information concerning how the user perceives the comfort level of the user's environment at the time the user supplies the information. The computer data processing system may determine and generate the control information for controlling how the environmental control system controls the environment based on the information concerning how each user perceives the comfort level of the user's environment at the time each user provides the information. In addition or instead, the computer data processing system may determine and generate such control information based on the information concerning how a user perceives the comfort level of the user's environment at the different times the user supplies the information.

Each report may indicate whether the user wants an increase, decrease, or no change in a particular environmental condition. The computer data processing system may determine and generate the control information for controlling how the environmental control system controls the environment based on whether each user wants an increase, decrease, or no change in a particular environmental condition.

Each report that indicates that a user wants an increase or a decrease in a particular environmental condition may include information indicative of a desired degree of the increase or decrease. The computer data processing system may determine and generate the control information for controlling how the environmental control system controls the environment based on the information provided by each user indicative of a desired degree of the increase or decrease.

Each report may identify a location of the user at the time the user supplied the information. The computer data processing system may determine and generate the control information for controlling how the environmental control system controls the environment based on the identified location of each user.

The location in each report that is identified may include information identifying a building, floor level, and/or room in which the user was present at the time the user supplied the information. The computer data processing system may determine and generate the control information for controlling how the environmental control system controls the environment based on the information identifying a building, floor, and/or room in which each user was present at the time each user supplied the information.

Each report may identify the user that supplied the information in the report. The computer data processing system may determine and generate the control information for controlling how the environmental control system controls the environment based on the identification of each user that supplied the information in each report.

The information in each report may concern how the user perceives the comfort level of the temperature, humidity, lighting, and/or air flow of the user's environment at the time the user supplies the information. The control information that is determined and generated may control how the environmental control system controls the temperature, humidity, lighting, and/or air flow of environment.

The computer data processing system may generate and store a model of a user preferences based on the information concerning how the user perceives the comfort level of the user's environment at different times the user supplies the information and based on at least one condition of the environment at each of the different times. The computer data processing system may determine and generate the control information for controlling how the environmental control system controls the environment based on the model.

The computer data processing may map each of multiple ranges of an environmental condition to a level of user comfort, store the map, and determine and generate the control information for controlling how the environmental control system controls the environment based on the map.

The computer data processing system may determine whether a user is likely to be within the environment at a particular time based on the information concerning how the user perceives the comfort level of the user's environment at the different times the user supplies the information. The computer data processing system may determine and generate the control information for controlling how the environmental control system controls the environment at a particular time based on whether the user is likely to be within the environment at that particular time.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a user interface for an environmental control system, including a thermal preference scale.

FIG. 2 illustrates an example of a data set collected from a user and assigned fuzzy sets on thermal preference ranges.

FIG. 3 illustrates schematics of an HVAC system in a test bed building.

FIG. 4 illustrates data flow in an HBI-TC framework implementation.

FIG. 5 illustrates an IDEF0 representation of an HBI-TC framework.

FIG. 6 illustrates a floor plan of zones in an experimental study.

FIGS. 7A-7D illustrate learned thermal comfort profiles of two participants.

FIGS. 8A-8B illustrate multiple users' thermal comfort ranges and their ratings for an HBI-TC framework implementation performance.

FIGS. 9A-9C illustrate examples of targeted room temperature time series and user comfort profile margins.

FIGS. 10A-10C illustrate temperature time series for three sample operation days of an HVAC system under three operating modes for three experimental zones.

FIG. 11 illustrates variation of air flow for different values of kₚ.

FIG. 12 illustrates a comparison between variation of daily average air flow in 2011 (BMS-22.8) versus 2012 (HBI-desired).

FIGS. 13A-13B illustrate a benchmarking process and a sample inter-zone regression analysis.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

Implementations and evaluations of frameworks that integrate building occupants' personalized thermal profiles into HVAC control logic is now presented. The framework may enable occupants to communicate their preferences for indoor thermal conditions through a user interface, leveraging a participatory sensing approach. The framework may learn occupants' comfort profiles, using a fuzzy predictive model, and may control the HVAC system using a complementary control strategy. This may enable the framework to be implemented in existing, centrally controlled HVAC systems with minimum intrusion.

Evaluation of the framework for user comfort showed that the framework has potential for improving comfort based on users' subjective ratings. The results showed a 39% reduction in daily average airflow when the HVAC system conditions the rooms at occupants' desired temperatures. Airflow can be proportional to the energy consumption of the HVAC system components. Consequently, the implementation of the framework shows improvements in the efficiency of the HVAC system's performance for centrally controlled office buildings.

Now proposed and validated is a framework for integrating building occupants' thermal preference profiles into the HVAC control logic to avoid using unrepresentative predefined HVAC operational settings. The proposed framework is founded on the hypothesis that it is possible to learn occupants' thermal preference profiles, integrate them into the control logic of HVAC systems, and improve system efficiency in existing buildings. The framework may enable occupants to continuously communicate their thermal preferences to a building management system (BMS) through a participatory sensing approach for HVAC system operations. The proposed framework can provide minimally intrusive, personalized HVAC control in commercial buildings and may include a complementary and non-intrusive control algorithm, which may enable an HVAC system to provide and maintain preferred indoor thermal conditions. A complementary controller may work with an existing legacy HVAC controller, which controls the flow rate, air temperature, and ventilation in the building.

In order to test the above-mentioned hypothesis, the proposed framework has been deployed and evaluated in a real building setting with permanent occupants. The evaluation is performed assessing the efficiency of the HVAC system performance by exploring the effect of the framework on occupants' comfort and the associated energy consequences.

Considering the above noted challenges of thermal comfort, the proposed user-led thermal comfort driven HVAC control framework seeks a number of objectives: (1) integrating the context dependent information of building occupants in the control mechanisms of HVAC systems through participatory sensing; (2) learning occupants thermal comfort profiles to be used in HVAC operations; (3) controlling the HVAC system to provide and maintain thermal preferences, and (4) providing a solution, which could be implemented in existing buildings with minimum intrusion. The core components of the framework are its ability to learn personalized thermal comfort profiles over time and its ability to operate the HVAC set points based on the learned personalized comfort profiles by implementing a complementary decentralized (room based control as opposed to thermal zone based) control strategy, which is integrated with the legacy HVAC system.

Many factors can drive comfort preferences of occupants in a building including physical, physiological, psychological, and cultural factors. A number of studies have demonstrated that prediction methods in standards, such as the ones in the ASHRAE 55, tend to overestimate or underestimate a user's thermal comfort votes, see R. Becker, M. Paciuk, “Thermal comfort in residential buildings—Failure to predict by Standard model”, Build. Environ. 44 (2009) 948-960; N. H. Wong, S. S. Khoo, Thermal comfort in classrooms in the tropics, Energy Build. 35 (2003) 337-351; T. J. Doherty, E. Arens, “Evaluation of the physiological bases of thermal comfort models”, ASHRAE Trans., 94, 1371-1385. (1988); K. C. Parsons, “The effects of gender, acclimation state, the opportunity to adjust clothing and physical disability on requirements for thermal comfort”, Energy Build. 34 (2002) 593-599.

A participatory sensing approach may be used to obtain context-dependent information from building occupants. The participatory sensing approach may rely on an increasing application of ubiquitous computing devices, such as portable computers, smartphones, and tablets. Participatory sensing provides the opportunity for capturing contextual information, which may inherently embrace all different driving factors, such as local changes in heat loads, varied sensitivity of users, etc. However, participatory sensing may also require a well-designed interface, which may facilitate accurate, fast, and frequent data acquisition to avoid user fatigue during data provision.

In thermal assessment studies, a number of thermal comfort sensation scales have been proposed for assessment of building occupants' perceptions. These scales include the ASHRAE thermal sensation scale, the Bedford comfort scale, the McIntyre 3-point preference scale, and the acceptability scale. Due to the complex nature of thermal comfort, using a combination of these scales has been recommended, see Nicol, “A Handbook of Adaptive Thermal Comfort: Towards a Dynamic Model”, Low Energy Architecture Research Unit, London Metropolitan University, London (2008), to ensure that an accurately representative occupant comfort is obtained. However, the use of combined scales may require a user to go through a multiple-thread interface, which may potentially result in confusion and the data analysis may become complicated.

To address these issues, a thermal preference scale may be used. The functionality of thermal sensation scale and preference scale may be integrated into one scale with a range of intensity. The consistency of the user input may be increased. Consistency may be defined as users' capability to be consistent in reporting their own individual preferred thermal conditions.

FIG. 1 illustrates an example of a user interface for an environmental control system, including a thermal preference scale. As illustrated in FIG. 1, the user interface may include a user-adjustable slider 101 with snapping capabilities, i.e., that may only be positioned by the user at one of several discrete values on a slider scale 103. Details of a user interface design and evaluation may be found in F. Jazizadeh, F. Marin, B. Becerik-Gerber, “A Thermal Preference Scale for Personalized Comfort Profile Identification via Participatory Sensing”, Building and Environment (2013) Vol 68, pp:140-149.

By moving the slider 101 to the left or right, users may express their preferences for various degrees of a warmer 105 environment, various degrees of a cooler 107 environment, or no change 109 to the environment. At the same time, their perception of the indoor environment may be captured and stored along with data indicative of the environment, such as its temperature, humidity, carbon dioxide, and/or light intensity.

The numeric values associated with the slider button position, which in this context may be called a thermal perception index (TPI), may show the intensity associated with a user's vote. This scale, along with a user location module, may be implemented in a single page user interface for different platforms, such as in smartphones and web browsers.

A prototype of the interface was developed for buildings on the University of Southern California campus for data collection and validation. The interface provides an area for users to input their location, such as in the form of a building name 113, a floor 115 of the building, and a room number 117. User locations may be used for association of votes and they may be used and optionally only used for HVAC system operations. The user identities may not be revealed or used for any other purpose.

For mobile devices, such as smartphones or tablets, only the buildings that are nearest buildings to a user's location may be presented as choices to the user, such as the five nearest buildings. To find the nearest buildings, GPS-based location information may be captured when a user is outside the building by the smartphone or tablet. User location may then be compared to coordinates of buildings in the area, such as on the campus. In case a web application version of the interface is used, the IP ranges of buildings may be used for presenting possible buildings to choose from. If user location information is not available, then an alphabetical list of campus or other organizational buildings may be provided.

Then users may navigate and scroll through the floors and rooms of their buildings using a drop down menu. The application may remember the history of browsing, which may help users provide fast and frequent feedback. Reducing manual data entry can facilitate sustained contribution and reduce the incidents of faulty data entry.

Variation in indoor environmental conditions may be captured and correlated with user provided votes to obtain personalized thermal comfort profiles. Therefore, sensing infrastructure, such as temperature, humidity, carbon dioxide, and/or light intensity at the location of each user and/or at representative locations may be a component of the proposed framework.

Legacy HVAC systems in buildings may monitor temperature variations at the thermal zone level. However, the sensor may be located in one room of a zone and may not provide a representative measure for distribution of indoor environmental conditions evenly in all rooms. Accordingly, a combination of sensors was installed in each room of a zone to determine the effective environmental variables on users' votes using room level sensor readings. Room level sensing may provide a better representation of the indoor environmental condition for each user.

A field study was conducted and a correlation analysis was carried out to investigate factors driving for user comfort votes. Temperature, humidity, carbon dioxide (as a measure of air ventilation in the room), and light intensity (as a measure of solar heat gain) values were studied, and the temperature values were found to be the most effective factor in driving user comfort votes. Details of this study could be found in F. Jazizadeh, F. Marin, B. Becerik-Gerber, “A Thermal Preference Scale for Personalized Comfort Profile Identification via Participatory Sensing”, Building and Environment (2013) Vol 68, pp:140-149. Both the user preference data and the environmental sensor data may be associated with user identity. In this way, the data is associated with users instead of locations. The identity of the user is determined either through direct input from the user by providing a user ID or by using an electronic identity of the devices that are used for data entry. For example, in case of using a smart phone, the phone ID may be attached to the data for personalization.

The framework may be designed to track occupancy patterns for efficient control of the HVAC system. These patterns may be used for occupancy estimation. In the framework, occupancy detection may be based on using ambient environment variation to enable detecting both the presence and number of occupants. Features from multiple sensors, including temperature, sound, light intensity, CO₂, motion, and infrared may be used for this detection. In this approach, when the training process is complete, new sensor data may be processed automatically to produce corresponding occupancy presence outcome.

Different classification algorithms, such as K-nearest neighbors, support vector machine, and decision tree, may be used. Based on occupancy detection results, models of space usage profiles have been developed. The modeling process may be done by statistically analyzing the space usage patterns over time, instead of using raw occupancy status directly, which might be affected by outliers or irregular occupant schedules. In the calculation of space usage patterns, pattern recognition modeling, including time series analysis, stochastic process modeling and random process modeling, may be used. Ambient context gathered from wireless sensors may be integrated in profile modeling for distinguishing regular schedules from irregular schedules. The outcome may be space usage patterns with confidence level associated with different times of day which, in turn, may be used for controlling an HVAC system in intelligent conditioning of the environment.

### Learning Personalized Thermal Comfort Profiles

Through the user interface, occupants may report their preferences under different indoor environmental conditions. After a period of data collection, the user provided data and associated temperature values (obtained through the sensor network) may be matched.

FIG. 2 illustrates an example of a data set collected from a user and assigned fuzzy sets on thermal preference ranges. The horizontal axis shows values on a thermal preference scale (TPI values, ranging from −50 to 50). The vertical axis shows associated temperature values. As noted, each reported preference vote is associated with a range of temperature and the data has a fuzzy pattern due to the complex nature of comfort perception. A fuzzy pattern recognition approach is used in order to extract an underlying pattern in the data. This pattern includes temperature ranges associated with different reported votes (thermal perception ranges) and a customized scale for each user's preferences.

Although attire level may be one of the main driving factors in users' perception of the environment, measuring the attire level requires continuous information provision from the users and may not be a feasible solution in long term. Thus, the proposed learning approach may benefit from users' adaptiveness, once they are provided control over the environment. Accordingly, users may adjust their preferences for indoor thermal conditions with their attire level.

In order to extract patterns in the user provided data, M fuzzy sets p^{l},l=1, . . . , M may be assigned to the thermal preference votes (TPI values on the slider) that each user reported. These fuzzy sets may represent different thermal comfort perception ranges. Upon assigning the fuzzy sets, Wang-Mendel fuzzy pattern recognition approach, see Li-Xin Wang, “The WM method completed: a flexible fuzzy system approach to data mining”, IEEE Trans. Fuzzy Syst. 11 (2003) 768-82, may be used to determine the temperature ranges associated with the fuzzy sets for each user and to develop a descriptive model. FIG. 2 shows a typical fuzzy set assignment for one occupant's vote data.

For each (TPIᵢ,tᵢ) data point, a membership value (μₚ_{^{q}}(TPI)) may be computed using the definitions of the assigned fuzzy sets. Each data point may then be used to generate an IF-THEN rule for the fuzzy set with a maximum membership value (μₚ_{^{l*}}(TPI)>μₚ_{^{l}}(TPI) for all l=1, . . . , M) in the following form:
IF TPI, is in P^{l*}, THEN t is centered at tᵢ.
   and the weight of the rule (w) is equal to μₚ_{^{l*}}(TPI). The rules may be generated for all N data points. These N rules may then be divided into M groups that share the same IF part to be combined and form a single rule:
IF TPI, is in P^{l}, THEN t is in T^{l},
   where T^{l} is the triangular fuzzy set for the combined rule. In each group, N₁ initial rules may be combined. The representative temperature (tₐᵥ^{l}) associated with the combined rules are:

$${t}_{av}^{l} = \frac{{\sum }_{k = 1}^{{N}_{l}} {t}_{k}^{l} \cdot {w}_{k}^{l}}{{\sum }_{k = 1}^{{N}_{l}} {w}_{k}^{l}}$$

which is a weighted average of the temperature values in each fuzzy set, assigned to thermal preferences. In order to determine the comfort ranges and the custom scale, a predictive model (f(TPI)) may be obtained by using singleton fuzzifier, product inference engine as fuzzy inference engine, and center-average defuzzifier:

$$f ( T P I ) = \frac{{\sum }_{l = 1}^{M} {t}_{av}^{l} \cdot {μ}_{{P}^{l}} ( T P I )}{{\sum }_{l = 1}^{M} {μ}_{{P}^{l}} ( T P I )}$$

Using the predictive model, temperature values may be assigned to the boundaries between M fuzzy sets, originally assigned to the TPI values. The personalized thermal comfort profile, which determines the temperature ranges for various TPI values, may be obtained. The predictive model may be used as a personalized scale for each user to determine the requested temperature change.

### Complementary Control Strategy

The control loop of a typical large centrally controlled HVAC system may rely on one thermostat per zone, and the proximity of the thermostat to the air diffusers may determine the distribution of air and temperature in the rooms. Temperature distribution in all rooms of a thermal zone may not be uniform, which could bring about dissatisfaction. In some cases, it may not be physically possible to change the indoor room temperature to meet with the user-preferred temperature by only relying on the legacy HVAC system control mechanism. This may happen when the BMS sensor is dose to the diffusor in one room and the HVAC system is controlled by the temperature in that specific room, as the output of the BMS sensor may drive the temperature in all rooms of that zone. A complementary control strategy may be used which may rely on an additional temperature sensor network for receiving feedback from the environment. Application of a distributed sensor system in each room may enable the controller to keep the thermal condition in each zone closer to all of the zone's occupants' thermal comfort profiles. Optimum placement of the sensors may call for an extensive study of indoor microclimate. However, since both the user preference acquisition process and the control process use the same sensor system, the proposed sensing network may provide a better representation of a room's microclimate.

As mentioned above, ambient temperature may be the most effective factor in driving users' thermal preference votes. This fact may enable the HVAC temperature set point to be used as a control parameter. The control strategy may be as follows:

$${min}_{{S}_{p}} δ = \frac{1}{{N}_{r}} {\sum }_{i = 1}^{{N}_{r}} {T}_{r}^{i} - {T}_{pr}^{i}$$

$$s . t . {S}_{{p}_{min}} \leq {S}_{p} \leq {S}_{{p}_{max}}$$

$$Δ {S}_{p} = {k}_{p} \cdot δ \leq Δ {S}_{{p}_{max}}$$

where Nᵣ is the number of rooms in one thermal zone, Tᵣⁱ is the temperature reading from room i sensor, Tₚᵣⁱ is the preferred temperature in room i, Sₚ is the zone VAV (variable air volume) box temperature set point, and Sₚ_{ₘᵢₙ} and Sₚ_{ₘₐₓ} determine the range of set point variations to avoid excessive temperature change in a thermal zone. The algorithm is a proportional algorithm, which may minimize 8, the sum of deviations from the preferred temperatures in all rooms of a zone. The optimum Sₚ may be proportionally achieved by adjusting ΔSₚ as the step change of the set point by using kₚ as proportional coefficient. ΔSₚ_{ₘₐₓ} may determine the maximum step change in each iteration.

### Framework Implementation

The implementation of the framework may be an extension to the legacy HVAC management system (BMS (building management system) hereafter) by incorporating the above-mentioned components into an integrated system. The framework, which is called HBI-TC (Human Building Interaction for Thermal Comfort), may be integrated into the operational logic of a centrally controlled HVAC system, for which occupants may have no control on the operation of the BMS. The implementation was carried out in an operational office building on University of Southern California campus.

### Test Bed Building

The test bed building is a three-story building, which houses offices, classrooms, and conference rooms. The building has 60 permanent occupants (office workers) and about 2000 temporary residents (students) per semester. The building is equipped with a centralized HVAC system, which is typical in modern office buildings in the United States. The HVAC system is centrally controlled with a state-of-the-art BMS. Two Air Handling Units (AHUs) serve the building with Variable Air Volume (VAV) boxes in each zone.

FIG. 3 illustrates the HVAC system in the test bed building. The supply air fans in the AHU circulate the air through the VAV boxes. The supply air is conditioned to ˜13° C. by the AHU. The return air fan applies a negative pressure to collect the air from each zone. The return air is mixed with the outside air in the AHU and is conditioned to a constant temperature by passing it through cooling coils. The VAV boxes control the zone level thermal conditions by variable volume of air with a constant temperature. A minimum air flow for thermal zone is enforced in order to ensure proper ventilation for maintaining the indoor air quality. The test bed has been equipped with 55 HBI-TC sensor boxes in the offices of permanent occupants in the second and third floor of the building. Sensor boxes include the temperature sensors and a number of other ambient sensors, used for occupancy detection. Therefore, sensor boxes were installed close to the door of each room at a height of 4 to 5 feet. A commercially-available MaxDetect, RHT03 temperature/humidity sensor was used. Temperature measurement accuracy is ±0.2° C. and the resolution (sensitivity) is 0.1° C. The sensor system uses a commercially-available Arduino Black Widow stand-alone single-board microcontroller with integrated support for 802.11 WiFi communications.

### HBI-TC Framework System Integration

At the core of the framework is an HBI-TC server, which manages the flow of data between the sensor nodes and the BMS. The server hosts a relational database, in which all data with time stamps are stored. Occupants in the building can access the user interface either through a URL on a web browser or by installing a smartphone application, available on Apple Store and Google Play. The prototype, used in this study, is a snapping thermal preference scale with five degrees both in warmer and cooler sides with TPIs from −50 to 50. The user provided data, including user location and preference votes, are matched with the closest data from the temperature sensors through the HBI-TC server. The complementary control resides on the HBI-TC server and is fed by the real time data from the temperature sensors in the building and users' comfort profile data that reside on the server. The server communicates to the BMS BACnet workstation to adjust the system set points dynamically and in real time.

FIG. 4 illustrates data flow in the HBI-TC framework. The process starts with a training period during which occupants interact with the system in order for HBI-TC to capture their preferences and associated ambient temperature values. During the training process the early morning temperature is set at different values so that occupants could experience different temperature ranges and react accordingly. During the training period, the requested change in temperature is calculated based on a linear relationship between the TPI values and temperature changes. Upon completion of the training period, the HBI-TC profiler retrieves the data set for each occupant and the comfort profiles are generated using the fuzzy predictive model described above. From this point on, the HBI-TC controller uses the preferred temperature values for each user and adjusts the zone temperature accordingly. In this way, instead of using a static set point during the day, the set point is dynamically set and reacts to variations of different sources of heating or cooling loads in each zone. During this stage, user requested temperature changes are determined according to the personalized scale for each user profile. The HBI-TC control algorithm reacts to a user's requests to address local discomfort; however, it returns room control temperature to the user preferred (desired) temperature after a short period of time. This period depends on the time that the HVAC system takes to adjust indoor conditions. In our test bed, this time was set to 30 minutes. FIG. 5 illustrates an IDEF0 representation of the HBI framework.

### Framework Evaluation

### Experiments

In order to evaluate the performance of the HBI-TC framework, an experimental study was conducted. For the purpose of this experiment, four adjacent zones of the test bed building in the third floor were selected. Before the activation of the HBI-TC prototype in the building, an email was sent to all permanent occupants of the test bed, describing the objectives of the study as well as the instructions for accessing the user interface. The occupants were asked to provide their votes during the day for at least four times. This preliminary data collection process continued for two weeks. Occupants that showed more interest in participating (based on the number of votes) were selected as participants in the long-term study.

FIG. 6 illustrates a floor plan of zones in an experimental study. FIG. 6 shows the plan view of the selected four zones: two zones with two rooms and two zones with three rooms. The rooms are on the south and north sides of the building and all of the rooms have large windows with controllable blinds. The rooms are single occupancy rooms with permanent occupants. An Institutional Review Board (IRB) approval was obtained for the study.

Three control modes were tested for operating the HVAC system and comparing the framework's impact on energy consumption and occupant comfort. The first mode is HVAC control by the BMS (i.e., the existing legacy control mode). In this mode, the VAV box operational set points were set to a constant temperature (˜22.8° C.) for all of the targeted zones—it is called “BMS-22.8” hereafter. The second mode is HVAC control by the HBI-TC controller (i.e., the proposed control algorithm) that uses personalized comfort profiles. In this mode, the set point, in each zone, is dynamically set by the HBI-TC controller—it is called “HBI-desired” hereafter. The third mode is HVAC control by the HBI-TC controller using the predefined constant temperature set point (˜22.8° C.) for all of the targeted zones—it is called “HBI-22.8” hereafter. The reason behind having three modes is the BMS controller cannot provide and maintain a uniformly distributed temperature in every room of a zone by design and the temperature distribution is dependent on the location of the BMS sensor in the zone and the proximity of the sensor to the diffusor. Therefore, using distributed HBI-TC sensors in the zones and using the complementary HBI-TC controller may facilitate the provision and maintenance of a uniformly distributed thermal conditions at the room level, which results in thermal comfort improvements. Accordingly, for the evaluation of the comfort consequences of the HBI-TC framework, the HBI-desired and BMS-22.8 are compared (proposed control vs. legacy HVAC control). For the evaluation of the energy consequences of the HBI-TC framework, two operational modes are compared: (1) HBI-desired and BMS-22.8 to compare the proposed framework to the legacy HVAC control; and (2) HBI-desired and HBI-22.8 to compare the energy consequences of controlling the zones with two different policies for the same controller—preferred (desired) temperature versus predefined temperature set points. All modes controlled the targeted zones during the operational hours (6:30 to 21:00).

One out of the four zones was used as a benchmarking zone. In the other three zones, six occupants out of seven rooms participated in the experiments. The seventh room (Room 4 in FIG. 6) was unoccupied. The first test period was from Oct. 15 2012 to Dec. 20 2012. The objectives of this test period were to evaluate the comfort consequences through user interactions with the HBI-TC enabled control and to explore the energy consumption consequences of the BMS-22.8 and HBI-desired modes. During this test period, two weeks were used for the training and after the training; the zones were controlled based on the learned thermal comfort profiles until the end of the experiment. In the second test period, the experiment was conducted for four weeks during April 2013 to June 2013. In this test period, the targeted zones were controlled by the HBI-desired for two weeks and HBI-22.8 for another two weeks. The learned thermal comfort profiles of the occupants in the first period were used for the second period.

### Evaluation Metrics

As noted, a main objective of the HBI-TC framework is to improve the efficiency of centrally controlled HVAC systems. As defined earlier, efficiency may be evaluated through measuring occupant comfort and calculating the energy consumption consequences of the HBI-TC implementation. Thermal comfort may be “a condition of mind, which expresses satisfaction with the thermal environment” and therefore subjective. Measuring biological signals from a user's body or asking for a user's subjective opinions are two possible methods for measuring comfort. The former was not chosen for this study due to its intrusive nature. Subjective opinions could be measured implicitly through counting the number of votes from users or explicitly through interviews.

Due to the fact that users were reminded to provide their feedback during the training period, comfort measurement through counting the number of feedback votes could result in biased conclusions. Accordingly, user interviews at different stages of the experiments were used for assessing comfort consequences of the framework. During these interviews, participants were asked to determine their satisfaction with their indoor environment on a scale of 1 to 10, 1 being the lowest satisfaction and 10 being the highest satisfaction. The interviews were conducted three times: (1) before enabling the framework; (2) at the end of the two week training period (the first period); and (3) at the end of the period when the zones were controlled based on users' personalized thermal comfort profiles (i.e., the HBI-desired mode or the second period).

Cooling process in the AHU, positive pressure applied through the supply air fans, possible heating process in the VAV boxes, and negative pressure applied in the return air fan are contributing processes in energy consumption of an HVAC system. The cool and hot water that is used for cooling and heating processes is conditioned in a central plant, which could serve a number of buildings (which is also the case for the test bed building). The accurate measurement of the HVAC energy consumption may require sub-metering of AHU electricity consumption, as well as sub-metering of heating and cooling energy that is associated with specific AHUs and VAV boxes. However, this may require metering of all of the zones that an AHU is serving. To find a metric for measuring energy in individual zones, an approximated measure is considered for energy consumption for temperature change and the energy consumed in air fans. The required energy for temperature variation could be obtained by:

Q=\dot{m}CₐΔT

where Q is the energy for change in temperature, \dot{m} is the air flow, Cₐ is the air heat capacity, and ΔT is the temperature change before and after heating or cooling. The cooling is performed by mixing the return air and outside mixed air. Temperature of the mixed air may depend on the volume and the temperature of the air coming from each source. The volume of each source may be determined by the HVAC economizer, which seeks optimized energy consumption for cooling. Accordingly, determining the temperature for energy calculation can be a challenging task.

However, the contribution of each zone in the cooling energy consumption may be proportional to the airflow of each zone based on the continuum equation. Heating process, which is performed at the VAV level, may also be proportional to the zone airflow. For the supply and return fan, the power consumption may also be proportional to the airflow passing through the fans. Therefore, in this study, airflow variation is used as the evaluation metric since relative changes in the energy consumption in different operational modes is needed.

### Findings

### Comfort Consequences

Upon training for two weeks, the thermal comfort profiles of the participants of the six rooms were generated and used for the HBI-TC control algorithm. The parameters of the comfort profile learning algorithm were set based on an extensive assessment done for improving the accuracy of the comfort profiles. Details of these assessments can be found in F. Jazizadeh, A. Ghahramani, B. Becerik-Gerber, T. Kichkaylo, M. Orosz, “A Human-Building Interaction Framework for Personalized Thermal Comfort Driven Systems in Office Buildings”, J. Comput. Civ. Eng. (2013), doi: 10.1061/(ASCE)CP.1943-5487.0000300.

FIGS. 7A-7D illustrate learned thermal comfort profiles of two participants. As seen in these figures, the comfort profile has two components: (1) the comfort ranges (lower part of the figures), which are defined based on the fuzzy predictive model and the assigned fuzzy sets for the TPIs; (2) the customized scale (upper part) for each user. As the scales in FIG. 7 show, participants have different levels of sensitivity to different conditions of temperature variations. These scales are used for reacting to users' feedback after the training period is over. Different fuzzy sets in the comfort profiles may determine different ranges of users' comfort. The central fuzzy set with gray shade determines the preferred temperature zone for each user. In this study, the temperature in the center of this fuzzy set is used as preferred (desired) temperature for control purposes.

The comfort profiles of six users in the targeted zones were used as the default operating desired temperature ranges during the post-training period. Once the personalized comfort profiles were obtained, upon the receipt of a new request, the requested change in temperature was calculated using the customized scale of each user's comfort profile and the temperature change was passed to the controller as the desired temperature for that user. The change was reversed after 30 minutes to the default value. The observations of the HVAC system reaction time were used in determining this 30-minute interval. After receiving a vote from a user, new requests from the same user were ignored for 30 minutes to ensure that user local discomfort does not cause excessive changes in the HVAC system. In the preliminary testing of the HBI-TC framework and before enabling the framework in the building, the observations in the targeted zones showed that it may not be possible to reach the temperature that a user might ask because of the minimum airflow setting of the VAV boxes. The reason was that the minimum airflow for the VAV boxes was set to ˜5.7 m³/Min. This airflow has been set to ensure that a conservative cool environment could be achieved. Therefore, the minimum airflow of the zones were reduced and set to ˜3 m³/Min for the HBI-TC framework. The reduction of the air flow was considered in accordance with the Ventilation for Acceptable Indoor Air Quality (ASHRAE standard 62.1—2007). The reduction of the air flow shows a 59% of air flow reduction in HVAC operations for BMS mode before and after minimum airflow adjustment. However, as it is illustrated in FIG. 10, the BMS mode with reduced minimum air flow results in an undercooled indoor environment.

FIGS. 8A-8B illustrate the thermal comfort ranges of the participants (FIG. 8B) and the results from the comfort assessment (FIG. 8A). The participant in room 1 stated that his presence was intermittent in the room after the training period and he preferred not to rate the performance of the system for the post-training period. As this figure shows, the average of the rating before training is 4.7 out of 10 possible points. During the training period, user comfort was slightly improved to an average of, 6 out of 10 possible points, and during the post-training period the average vote increased to 8.4 out of 10 possible points, which shows potential for user comfort improvements for the experimental group although the difference is not statistically significant for statistical generalization. The sensitivity analysis showed that a larger sample of 20 or more participants may be required for statistical significance. In addition to quantitative subjective ratings, the participants stated their satisfaction with the implemented framework and they expressed their enthusiasm about keeping the framework active in the budding. Moreover, the improved user experience implicitly supports the users adaptive abilities.

FIGS. 9A-9C illustrate examples of targeted room temperature time series and user comfort profile margins. The performance of the HBI framework in providing the desired thermal condition is shown in FIGS. 9A-9C. These FIGS. illustrate the variation of room temperatures in each room, the users' preferred (desired) comfort temperature range, and lower bound desired temperature and upper bound desired temperature for a sample day. As could be seen in zones 1 and 2, the room temperature variations were in the comfort zone limit of the users. As mentioned before, room 4 was vacant. In zone 3, the related profile for room 6 was disabled in the HBI-TC control algorithm as the occupant of room 6 was not in the office (for the day of the presented data), and the temperature time series for rooms 5 and 7 are shown. The average temperature for room 5 is out of the comfort range for half a degree Celsius, which is due to the averaging policy that is used in the HBI-TC control algorithm. As the subjective votes show, the user in room 5 expressed a considerable improvement for his/her thermal comfort levels. This may be due to the fact that the thermal condition provided by the new HBI-TC controller is closer to the user's thermal preference range compared to the time that HVAC was solely controlled by the BMS.

FIGS. 10A-10C illustrate temperature time series for three sample operation days of an HVAC system under three operating modes for three experimental zones. The figures show a comparison between different operational modes (i.e., BMS-22.8, HBI-22.8, and HBI-desired) to explore the possibility of improving the temperature distribution and keeping the temperature close to the users' preferences with the HBI-TC control algorithm. The graphs show a sample day for each condition, and the temperature time series are average temperatures of all the rooms in each zone. Mean lower bound and upper bound are the average of desired temperature range lower and upper bounds for the occupants of one zone.

As it is shown, using the BMS-22.8 mode resulted in high temperatures in the rooms. This happened due to the changes in the minimum airflow setting of the VAV boxes. Accordingly, to achieve lower temperatures, the minimum airflow should have been increased in order to cope with the improper location of the BMS sensors. This is the reason behind the dissatisfaction of occupants and their perception of the indoor environment as somewhat cool to cold before HBI-TC implementation.

FIGS. 10A-10C also show the performances of HBI-desired and HBI-22.8. As could be seen, the HBI-desired is successfully conditioning zones' indoor environment to be compatible with users' preferences. The improvement in performance of the HVAC is achieved through application of room level sensors and the complementary HBI-TC controller.

### Energy Consumption Consequences

In proportional controllers, tuning of the proportional coefficient is an essential step to avoid excessive oscillations, which could result in excessive energy consumption in HVAC system operations. Accordingly, as a first step, the tuning of the kₚ coefficient was performed to find the best coefficient. In this process 0.25, 0.4, 0.6, and 1 were used for the coefficient and the HBI-TC control algorithm was run for a day with each one of these coefficients.

FIG. 11 illustrates variation of air flow in zone 1 for different values of kₚ as an example. As it is shown in this figure, kₚ=0.4 was found to be the best coefficient among the tested ones, with decreased oscillation. The increase in the airflow at the beginning of the day is part of the scheduled operation of the BMS for the initial conditioning of the indoor environment.

The energy consequences of the complementary control algorithm were evaluated by studying two comparative cases. The first comparison was done between the HBI-desired and the BMS-22.8. For the comparison, the data from October to December of 2011 was used. Many factors could affect the airflow variations including outside temperature and activities in the zones. The comparison was performed between the days with similar outside temperature ranges. Since the length of the period of comparison is relatively long and the same occupants used the rooms in both years with almost similar activity patterns, we compared the daily average airflow variations directly.

TABLE 1
The comparison of average daily air flow variation
between HBI-desired and BMS-22.8

| Mode | Zone 1 | Zone 2 | Zone 3 | Overall |
|---|---|---|---|---|
| 2012 HBI-desired | 5.14 | 8.21 | 5.42 | 6.26 |
| 2011 BMS-22.8 | 9.48 | 9.51 | 11.69 | 10.23 |
| Variations | −46% | −14% | −54% | −39% |

Table 1 shows the results of the comparison with an overall 39% reduction in daily average airflow. In this comparison, air flow values for the BMS mode were collected before implementation of the HBI-TC and therefore the minimum air flow was higher. As it is shown in FIG. 10, the reduction in minimum air flow results in undercooling condition in case of operating in the BMS mode. This is the reason behind the higher energy consumption in the BMS mode operation.

FIG. 12 illustrates a comparison between variation of daily average air flow in 2011 (BMS-22.8) versus 2012 (HBI-desired). In order to illustrate the reason for the observed savings, in FIG. 12, the comparison between daily average airflows for a period of 30 days in 2011 and 2012 are presented. Taking the performance of the BMS mode in FIG. 10 and FIG. 12 into account shows the lower efficiency of the BMS operational mode. The comparison shows high rate of airflow in 2011 compared to the airflow values of the HBI-desired operational mode in 2012. The energy impact of heating at VAV boxes for the HBI-desired and BMS modes was investigated by comparing the average percentages of the time that the VAV heating valves were open. These percentages are 7.32% in zone 1, 4.12% in zone 2, and 0.9% in zone 3 for HBI-desired operational mode, and 2.84% in zone 1, 1.66% in zone 2, and 0.35% in zone 3 for the BMS operational mode. As it could be seen the heating system of the VAV boxes was not active in majority of the operational periods for either of the strategies. As a result, airflow variation was considered as the main metric for comparisons between different modes of operation.

The second comparison was done between the HBI-desired and HBI-22.8. The comparison was carried out in different modes for four weeks: two weeks using the HBI-desired mode and two weeks using the HBI-22.8 mode. In order to conduct a fair comparison between the two control modes, a benchmarking approach was adopted. Zone 4, which is in close proximity to the experimental zones, was used as the benchmark zone.

FIGS. 13A-13B illustrate a benchmarking process and a sample inter-zone regression analysis. In the benchmarking process, the daily average airflow of each one of the zones in the HBI-22.8 mode was mapped to an equivalent daily average airflow of the BMS-22.8 mode (shown as _{˜}AF^{z}_{BMS} in FIGS. 13A-13B). Zone 4 was always operated in the BMS-22.8 mode. When the targeted zones are operated based on HBI-22.8 mode, a regression analysis was carried out to obtain the relationship between the daily average airflow in the benchmarking zone and the other zones (depicted as AF^{z}_{HBI}=f_{z}(AF*) in FIGS. 13A-13B). Using the regression curves for comparison, the equivalent daily average airflow of the zones in the HBI-22.8 mode for the period of the HBI-desired operation mode was obtained. FIG. 13 also shows the results of the linear regression analysis between zone 1 and the benchmark zone as an example.

TABLE 2
Variation of average daily airflow in targeted zones for
the HBI-22.8 mode versus HBI-desired mode

| Mode | Zone 1 | Zone 2 | Zone 3 | Overall |
|---|---|---|---|---|
| HBI-22.8 | 8.42 | 6.38 | 16.4 | 10.4 |
| HBI-desired | 5.48 | 9.45 | 8.08 | 7.67 |
| Variations | −35% | 48% | −51% | −26% |

The airflow variations are presented in Table 2 by benchmarking and calculating the energy consumption of the HBI-22.8 and HBI-desired modes. The overall airflow in the HBI-desired mode has been decreased by 26%. The HBI-22.8 mode is the mode that a more uniform distribution of conditioned air is possible (due to the HBI-TC sensor boxes in each room) for predefined temperature set points. As mentioned in section 2, a high percentage of the occupants were dissatisfied, perceiving their indoor environments as cool to cold. Accordingly, the HBI-TC framework could potentially reduce energy consumption in the building by learning all permanent occupants' thermal comfort profiles.

### Limitations

In this study, the proposed framework has been designed and evaluated for office buildings with closed office spaces equipped with a centrally controlled HVAC system. However, in buildings with open plan offices, in the absence of partitioned spaces, provision and maintenance of different microclimates could be a challenging task. The HBI-TC framework may be more suited for permanently occupied offices, where thermal comfort profiles for occupants could be established. In this study, the objective function focused on thermal comfort by using thermal preferences' zone level average. The energy efficiency of the HVAC system could be improved through the multi-objective optimization of energy and comfort and introduction of more advanced policies in HVAC operations.

### CONCLUSIONS

This study presents the results from the implementation and evaluation of a framework that integrates occupants' preferences in the operation of HVAC systems. The study tested the hypothesis that by operating the HVAC system based on occupants' comfort profiles, the system efficiency could be improved. Three zones of an office building were used for the validation of the hypothesis. The proposed framework uses a participatory sensing approach for user-BMS communications and learns user's comfort profiles, using a fuzzy predictive model, as users interact with the system to achieve their preferred indoor thermal conditions. The user comfort profiles are then utilized through a complementary control strategy at the zone level. The comfort and energy consumption implication of the proposed framework was evaluated through experimental studies. Interviews with the participants showed improvements in user satisfaction with their thermal comfort. The framework showed potential to improve comfort while reducing energy consumption. The evaluation of energy consumption of the proposed framework showed promising results for saving energy. The results showed a 39% reduction in daily average airflow rates (compared to the legacy HVAC system operations with predefined temperature set points). The comparison between the proposed framework control modes for users' desired temperatures versus predefined temperatures also showed a reduction in daily average airflow rates by 26%.

Unless otherwise indicated, the various algorithm, computations, and data flows that have been discussed herein may be implemented with a computer data processing system configured to perform these functions. Each computer data processing system may include one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer data processing system may be a desktop computer or a portable computer, such as a laptop computer, a notebook computer, a tablet computer, a PDA, a smartphone, a dedicated computer, or part of a larger system, such an HVAC system.

The computer data processing system may include one or more computers at the same or different locations. When at different locations, the computers may be configured to communicate with one another through a wired and/or wireless network communication system.

The computer data processing system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A computer data processing system that includes a hardware processor and that provides control information for controlling how an environmental control system controls an environment within a building, the computer data processing system having a configuration that:
receives and stores reports from multiple different users, each report providing information concerning how the user perceives the comfort level of the user's environment at the time the user supplies the information; and
determines and generates the control information for controlling how the environmental control system controls the environment based on the information concerning how each user perceives the comfort level of the user's environment at the time the user supplies the information.

2. The computer data processing system of claim 1 wherein:
each report indicates whether the user wants an increase, decrease, or no change in a particular environmental condition; and
the computer data processing system has a configuration that determines and generates the control information for controlling how the environmental control system controls the environment based on whether each user wants an increase, decrease, or no change in a particular environmental condition.

3. The computer data processing system of claim 2 wherein:
each report that indicates that a user wants an increase or a decrease in a particular environmental condition includes information indicative of a desired degree of the increase or decrease; and
the computer data processing system has a configuration that determines and generates the control information for controlling how the environmental control system controls the environment based on the information indicative of a desired degree of the increase or decrease.

4. The computer data processing system of claim 1 wherein:
each report identifies a location of the user that supplied the information in the report at the time the user supplied the information; and
the computer data processing system has a configuration that determines and generates the control information for controlling how the environmental control system controls the environment based on the identified location of each user.

5. The computer data processing system of claim 4 wherein:
the location in each report that is identified includes information identifying a building in which the user was present at the time the user supplied the information; and
the computer data processing system has a configuration that determines and generates the control information for controlling how the environmental control system controls the environment based on the information identifying a building in which each user was present at the time the user supplied the information.

6. The computer data processing system of claim 4 wherein:
the location in each report that is identified includes information identifying a floor in which the user was present at the time the user supplied the information; and
the computer data processing system has a configuration that determines and generates the control information for controlling how the environmental control system controls the environment based on the information identifying a floor in which each user was present at the time the user supplied the information

7. The computer data processing system of claim 4 wherein:
the location in each report that is identified includes information identifying a room in which the user was present at the time the user supplied the information; and
the computer data processing system has a configuration that determines and generates the control information for controlling how the environmental control system controls the environment based on the information identifying a room in which each user was present at the time the user supplied the information.

8. The computer data processing system of claim 1 wherein:
each report identifies the user that supplied the information in the report; and
the computer data processing system has a configuration that determines and generates the control information for controlling how the environmental control system controls the environment based on the identification of the user that supplied the information in each report.

9. The computer data processing system of claim 1 wherein:
the information in each report concerns how the user perceives the comfort level of the temperature of the user's environment at the time the user supplies the information; and
the control information that is determined and generated controls how the environmental control system controls the temperature of environment.

10. The computer data processing system of claim 1 wherein:
the information in each report concerns how the user perceives the comfort level of the humidity of the user's environment at the time the user supplies the information; and
the control information that is determined and generated controls how the environmental control system controls the humidity of environment.

11. The computer data processing system of claim 1 wherein:
the information in each report concerns how the user perceives the comfort level of the lighting of the user's environment at the time the user supplies the information; and
the control information that is determined and generated controls how the environmental control system controls the lighting of environment.

12. The computer data processing system of claim 1 wherein:
the information in each report concerns how the user perceives the comfort level of the air flow of the user's environment at the time the user supplies the information; and
the control information that is determined and generated controls how the environmental control system controls the air flow of environment.

13. A computer data processing system that includes a hardware processor and that provides control information for controlling how an environmental control system controls an environment, the computer data processing system having a configuration that:
receives and stores reports at different times from a user, each report providing information concerning how the user perceives the comfort level of the user's environment at the time the user supplies the information; and
determines and generates the control information for controlling how the environmental control system controls the environment based on the information concerning how the user perceives the comfort level of the user's environment at the different times the user supplies the information.

14. The computer data processing system of claim 13 wherein:
each report indicates whether the user wants an increase, decrease, or no change in a particular environmental condition; and
the computer data processing system has a configuration that determines and generates the control information for controlling how the environmental control system controls the environment based on whether each report indicates that the user wants an increase, decrease, or no change in a particular environmental condition.

15. The computer data processing system of claim 14 wherein:
each report that indicates that the user wants an increase or a decrease in a particular environmental condition includes information indicative of a desired degree of the increase or decrease; and
the computer data processing system has a configuration that determines and generates the control information for controlling how the environmental control system controls the environment based on the information in each report indicative of a desired degree of the increase or decrease.

16. The computer data processing system of claim 13 wherein:
each report identifies a location of the user that supplied the information in the report at the time the user supplied the information; and
the computer data processing system has a configuration that determines and generates the control information for controlling how the environmental control system controls the environment based on the identified location of the user in each report.

17. The computer data processing system of claim 16 wherein:
the location in each report that is identified includes information identifying a building in which the user was present at the time the user supplied the information; and
the computer data processing system has a configuration that determines and generates the control information for controlling how the environmental control system controls the environment based on the information identifying a building in which the user was present at each time the user supplied the information.

18. The computer data processing system of claim 16 wherein:
the location in each report that is identified includes information identifying a floor in which the user was present at the time the user supplied the information; and
the computer data processing system has a configuration that determines and generates the control information for controlling how the environmental control system controls the environment based on the information identifying a floor in which the user was present at each time the user supplied the information

19. The computer data processing system of claim 16 wherein:
the location in each report that is identified includes information identifying a room in which the user was present at the time the user supplied the information; and
the computer data processing system has a configuration that determines and generates the control information for controlling how the environmental control system controls the environment based on the information identifying a room in which the user was present at each time the user supplied the information.

20. The computer data processing system of claim 13 wherein:
each report identifies the user that supplied the information in the report; and
the computer data processing system has a configuration that determines and generates the control information for controlling how the environmental control system controls the environment based on the identification of the user that supplied the information in the report.

21. The computer data processing system of claim 13 wherein:
the information in each report concerns how the user perceives the comfort level of the temperature of the user's environment at the time the user supplies the information; and
the control information that is determined and generated controls how the environmental control system controls the temperature of environment.

22. The computer data processing system of claim 13 wherein:
the information in each report concerns how the user perceives the comfort level of the humidity of the user's environment at the time the user supplies the information; and
the control information that is determined and generated controls how the environmental control system controls the humidity of environment.

23. The computer data processing system of claim 13 wherein:
the information in each report concerns how the user perceives the comfort level of the lighting of the user's environment at the time the user supplies the information; and
the control information that is determined and generated controls how the environmental control system controls the lighting of environment.

24. The computer data processing system of claim 13 wherein:
the information in each report concerns how the user perceives the comfort level of the air flow of the user's environment at the time the user supplies the information; and
the control information that is determined and generated controls how the environmental control system controls the air flow of environment.

25. The computer data processing system of claim 13 wherein the computer data processing system has a configuration that:
generates and stores a model of the user based on the information concerning how the user perceives the comfort level of the user's environment at the different times the user supplies the information and based on at least one condition of the environment at each of the different times; and
determines and generates the control information for controlling how the environmental control system controls the environment based on the model.

26. The computer data processing system of claim 25 wherein the computer data processing system has a configuration that:
maps each of multiple ranges of environmental conditions to a level of user comfort;
stores the map; and
determines and generates the control information for controlling how the environmental control system controls the environment based on the map.

27. The computer data processing system of claim 13 wherein the computer data processing system has a configuration that:
determines whether the user is likely to be within the environment at a particular time based on the information concerning how the user perceives the comfort level of the user's environment at the different times the user supplies the information; and
determines and generates the control information for controlling how the environmental control system controls the environment at a particular time based on whether the user is likely to be within the environment at that particular time.

28. The computer data processing system of claim 13 wherein the computer data processing system has a configuration that:
receives and stores reports from multiple different users, each report providing information concerning how the user perceives the comfort level of the user's environment at the time the user supplies the information; and
determines and generates the control information for controlling how the environmental control system controls the environment based on the information concerning how each user perceives the comfort level of the user's environment at the time the user supplies the information.
